(19) United States
(12) Patent Application Publication
(10) Pub. No.: US 2004/0047634 A1
(43) Pub. Date: Mar. 11, 2004

(54) Optical wireless device

(76) Inventor: Takumi Nagai, Tokyo (JP)

Correspondence Address: Stroock & Stroock & Lavan, 180 Maiden Lane, New York, NY, 10038, US

(21) Appl. No.: 10/362,472

(22) PCT Filed: Sep. 11, 2002
(86) PCT No.: PCT/JP02/09316

(51) Int. Cl. H04B 10/00

(52) U.S. Cl. 398/118; 398/131

(57) ABSTRACT

It is an exemplary object of the present invention to provide an optical wireless device that easily and stably adjust and fix an optical axis. An inventive optical wireless device includes a communication part for optical communications. and an attachment part for rotatably supporting the communication part and fixing the communication part at a predetermined angle.

### TECHNICAL FIELD

The present invention relates generally to network devices, and more particularly to an optical wireless device for optical wireless communications. The present invention is suitable, for example, for an optical wireless device used to build a Local Area Network (“LAN”) between two spaced buildings.

### BACKGROUND TECHNOLOGY

Along with recent spread of networks, LANs have been frequently used on the same floor and in the same building, and Wide Area Networks (“WANs”) and Metropolitan Area Networks (“MANs”) have already been proposed for a system that connects networks in different places. However, the WANs and MANs use a dial-up adapter and a public network or need a layout of a leased line, and are therefore expensive due to the communication expense or leased line layout expense. Although the WANs and MANs are inevitable when two different places are distant, a simpler method has been demanded in creating a network between two neighboring buildings.

Accordingly, wireless LANs have conventionally been proposed which achieve wireless communications using light, radio waves, etc. instead of using a wire cable. Among them, a wireless LAN that uses radio waves utilizes, for example, of 2.4 GHz band and has such a fast maximum transmission speed as 11 Mbps, but it has a security disadvantage: In an attempt to use such a wireless LAN to connect a third floor of one building only with a eighth floor of another neighboring building, a communication range covers other floors in these buildings.

The instant inventor addresses a wireless LAN that communicates using an optical beam. The optical wireless communication uses two communication devices, one of which emits light, and the other of which receives the light for communication, and limits the communication range to these communication devices for improved security. The optical wireless communication requires optical axes of these two optical wireless to accord with each other, and these devices located at different heights, as described above, should maintain their optical axes stably at predetermined inclined angles in horizontal and perpendicular directions. No optical wireless devices have conventionally been proposed that may easily and stably adjust and fix their optical axis.

### DISCLOSURE OF THE INVENTION

Accordingly, it is an exemplified object of the present invention to provide an optical wireless device that may easily and stably adjust and fix its optical axis.

In order to achieve the above object, an optical wireless device includes a communication part for optical communications, and an attachment part for rotatably supporting the communication part and for fixing said communication part at a predetermined angle. According to this optical wireless device, the attachment part may adjust an angle of the communication part to a predetermined angle and fix it, thereby easily and stably adjusting and fixing the optical axis of the communication part for stable optical communications.

The attachment part may include a first angle adjustment part for adjusting the angle of the communication part to the predetermined angle, and a second angle adjustment part for providing a fine adjustment to the angle that has been adjusted by the first angle adjustment part, to the predetermined angle. According to this optical wireless device, the first angle adjustment part provides a rough adjustment to the angle of the communication part, and then the second angle adjustment part provides a fine adjustment to the angle of the communication part, providing the faster adjustment and fixation of the optical axis of the communication part than the adjustment using only one angle adjustment part.

Preferably, the first angle adjustment part includes a first rotary part for adjusting a horizontal angle of the communication part. According to this optical wireless device, the first rotary part adjusts a horizontal angle of the communication part, realizing optical communications using two optical wireless devices at different horizontal positions, e.g., two optical wireless devices located at two obliquely arranged buildings.

Preferably, the first angle adjustment part includes a second rotary part for adjusting a perpendicular angle of the communication part. According to this optical wireless device, the second rotary part adjusts a perpendicular angle of the communication part, realizing optical communications using two optical wireless devices at different perpendicular positions, e.g., two optical wireless devices located on different floors in two facing buildings.

For example, the first angle adjustment part includes a fixing part fixed at a predetermined position, a first rotary part rotatably attached to the fixing part, and a second rotary part that is attached to the first rotary part, and rotatable in a rotary direction orthogonal to the first rotary part, wherein one of the first and second rotary parts includes a pair of first projections aligned in a first direction and a pair of second projections aligned in a second direction perpendicular to the first direction, and wherein the other of the first and second rotary parts includes an arc-shaped groove engageable with one of the first projections and one of the second projections, and the second rotary part is rotatable with respect to the other of the first projections and the other of the second projections. The first angle adjustment part may include, for example, a fixing part fixed at a predetermined position, a first rotary part rotatably attached to the fixing part, and a second rotary part attached to the first rotary part, and rotatable in a rotary direction orthogonal to the first rotary part, wherein one of the first and second rotary parts includes a pair of projections, and the other of the first and second rotary parts includes an arc-shaped groove engageable with one of the projections, and the second rotary part is rotatable with respect to the other of the projections.

Preferably, the attachment part includes a fixing mechanism for fixing the communication part. Such a fixing mechanism includes, for example, a screw, a stepwise adjusting gear, or the like. As a result, it is possible to maintain the predetermined angle and prevent an offset between optical axes, providing stable optical communications. Preferably, the attachment part includes an engagement part for holding a cable connected to the communication part. This optical wireless device may prevent an entanglement, slip off, etc. of the cable. The second angle adjustment part is, for example, a pan head.

Preferably, the communication part includes a first transmitter/receiver part for emitting and receiving light for communications, a second transmitter/receiver part for emitting and receiving light for adjusting an optical axis, and a collimator for receiving light emitted from the second transmitter/receiver part of a communication counterpart. According to this optical wireless device, the light for adjusting the optical axis easily recognizes a positional relationship of mutual optical wireless devices and facilitates the adjustment of the light emission position of the optical wireless device, thereby easily and stably adjusting the optical axis.

### BRIEF DESCRIPTION OF THE DRAWINGS

FIG. I is a typical view of a computer network using an optical wireless device of one aspect according to the present invention.

FIG. 2 is a schematic perspective view of the optical wireless device shown in FIG. 1.

FIG. 3 is a block diagram showing a structure of a communication part in the optical wireless device shown in FIG. 2.

FIG. 4 is a schematic perspective view showing an attachment part in the optical wireless device shown in FIG. 2.

FIG. 5 is a schematic perspective view showing a rotary part as part of the attachment part shown in FIG. 4.

FIG. 6 is a schematic perspective view showing a fixing part as part of the rotary part shown in FIG. 5.

FIG. 7 is a schematic perspective view showing a first rotary member as part of the rotary part shown in FIG. 5.

FIG. 8 is an enlarged side view showing a variation of the first rotary member as part of the rotary part shown in FIG. 5.

FIG. 9 is a schematic perspective view showing a second rotary member as part of the rotary part shown in FIG. 5.

FIG. 10 is a schematic side view showing a moving direction of the rotary part in the optical wireless device shown in FIG. 2.

FIG. 11 is a schematic perspective view showing the optical communication device of another embodiment according to the present invention.

### BEST MODE FOR IMPLEMENTING THE INVENTION

Referring to accompanying drawings, a description will now be given of an inventive optical wireless device 10 and a network device 1 having the same. Here, FIG. 1(a) is a schematic sectional view of a computer network 1 built on different floors in two buildings using the optical wireless devices 10. FIG. 1(b) is a typical view of such a computer network.

In the instant embodiment, the computer network 1 includes two LANs in two buildings 2 and 3, and a pair of optical wireless devices 10 connecting these LANs. The LANs of this embodiment includes network devices 6a and 6b, such as a hub, router and a switch, a server 8, and clients 9a and 9b. In the following description, a numeral without a lowercase generalizes a numeral with a lowercase, such as 6a. The network devices 6 is connected to the optical wireless device 10, PC 9, and server 8.

Of course, an applicability of the present invention is not limited to a building, but covers a school, an apartment, and other buildings, as well as a WAN and MAN.

The buildings 2 and 3 face each other via windows 2a and 3a. In the instant embodiment, two LANs are provided at different heights or perpendicular positions (e.g., a third floor in the building 2 and an eighth floor in the building 3) as well as at different horizontal positions. In other words, buildings 2 and 3 are arranged obliquely. Of course, the present invention is applicable to two LANs at the same perpendicular positions and/or horizontal positions, and thus the windows 2a and 3a may be level with each other and/or face each other straightforward, not obliquely.

The server 8 and clients 9 are connected to the network devices 6 through an Unshielded Twisted Pair Cable (“UTP”). In this embodiment, the server 8 and 9 are implemented as a personal computer (“PC” hereinafter), but the server 8 and 9 applicable to the present invention include network devices, such as a hub, a switch, a router, another network devices, a repeater, a bridge, a gateway device, a PC, a server, and a wireless interconnecting device (such as a access point of an interconnecting device of a wireless LAN).

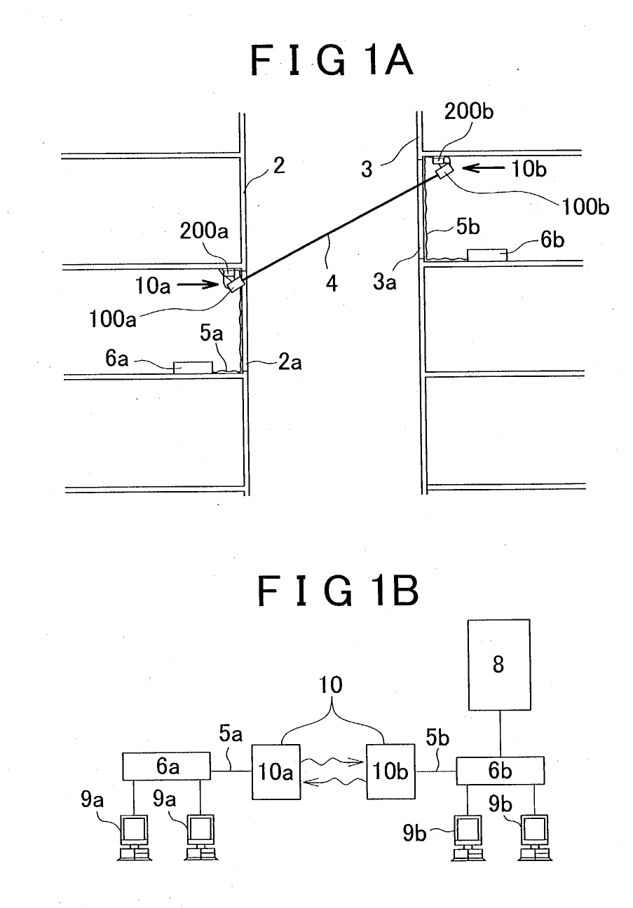

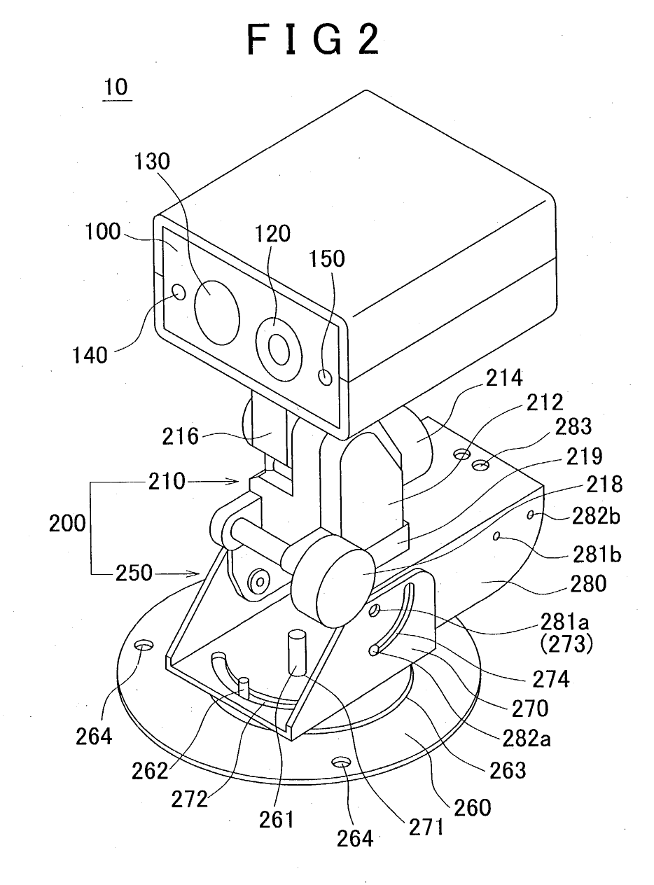

The optical wireless devices 10 are wireless LAN terminals for optical communications, arranged at a predetermined angle and orientation so that their optical axes accord with each other, and each include a communication part 100 and an attachment part 200. Although the optical wireless device 10 is provided on a ceiling of each of the buildings 2 and 3 in FIG. 1, it may be provided on a perpendicular surface, such as a wall and partition, a horizontal surface, such as a rack, and other surfaces, as described later. A description will now be given of the optical wireless device 10 with reference to FIGS. 2-10.

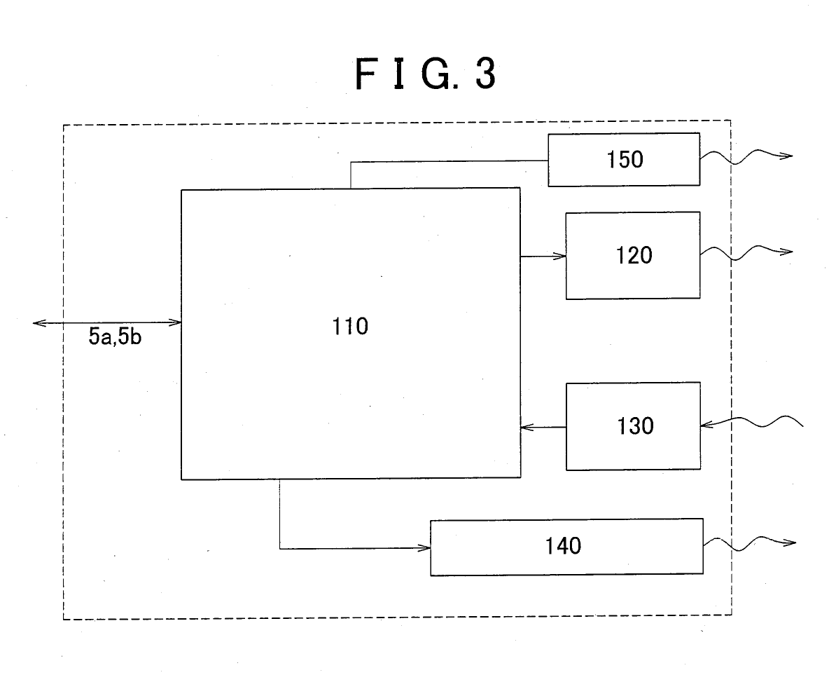

As shown in FIGS. 2 and 3, the communication part 100 executes optical communications and includes a converter part 110, a transmitter part 120, a receiver part 130, a laser pointer 140, and a collimator 150. Here, FIG. 2 is a perspective view of the optical wireless device 10. FIG. 3 is a block diagram of the communication part 100 in the optical wireless device 10. The communication part 100 is connected to the server 8 and client 9 through the UTP or LAN cable 5 and network devices 6, and maintains communications between the server 8 and client 9.

The converter part 110 processes an interface for communications between the server 8 and client 9, and controls the transmitter part 120, the receiver part 130, the laser pointer 140 and the collimator 150. The converter 110 modulates input signals from the server 8 and client 9, and adjusts the emitted light along the optical axis 4 to a preset reference value. For example, it measures the emitted light intensity along the optical axis 4, and compares the measured value with the present reference value. As a result of comparison, when the measured value is larger than the reference value, it adjusts the emitted light intensity of the optical axis 4 to be lower, while when the measured value is smaller than the reference value, it adjusts the emitted light intensity of the optical axis 4 to be higher.

The transmitter part 120 emits light including data to be communicated, along the optical axis 4 based on a modulated signal output from the converter part 110. The receiver part 130 receives optical axis 4 adjusted and input by an input light adjusting part, and converts into an electronic signal corresponding to the input light intensity. The receiver part 130 may use, for example, a diode.

The laser pointer 140 outputs an optical-axis adjusting laser beam under control of the converter part 110. This laser pointer 140 is used particularly for alignment between the optical wireless devices 10. The laser beam output from the laser pointer 140 is approximately collimated light. This laser pointer 140 may emit a laser beam of high directivity. The collimator 150 is located to receive the laser beam emitted from the laser pointer 140. Since the optical axis 4 is adjusted by confirming that the laser beam is irradiated onto this collimator 150, the laser beam emitted from the laser pointer 140 is preferably a beam as large as or larger than the collimator 150 provided on a front surface of the communication counterpart apart by about 100 m to 700 m. While the laser beam emitted from the laser pointer 140 is irradiated at least onto the collimator 150, the laser beam should has such directivity that the laser beam is not irradiated onto the receiver part 130. The light emitted from the laser pointer 140 may be selectively irradiated onto the collimator 150 provided in a region apart from the receiver part 130 on the front surface of the optical wireless device 10 of the communication counterpart.

The collimator 150 receives light emitted from the laser pointer 140 of the communication counterpart. This collimator 150 is used particularly for alignment between the optical wireless devices 10 in cooperation with the laser pointer 40. Preferably, the size of the collimator 150 is as the same as or larger than that of the light beam. However, more preferably, it is larger, but slightly, than the light beam for alignment with the communication counterpart apart by about 100 m to 700 m.

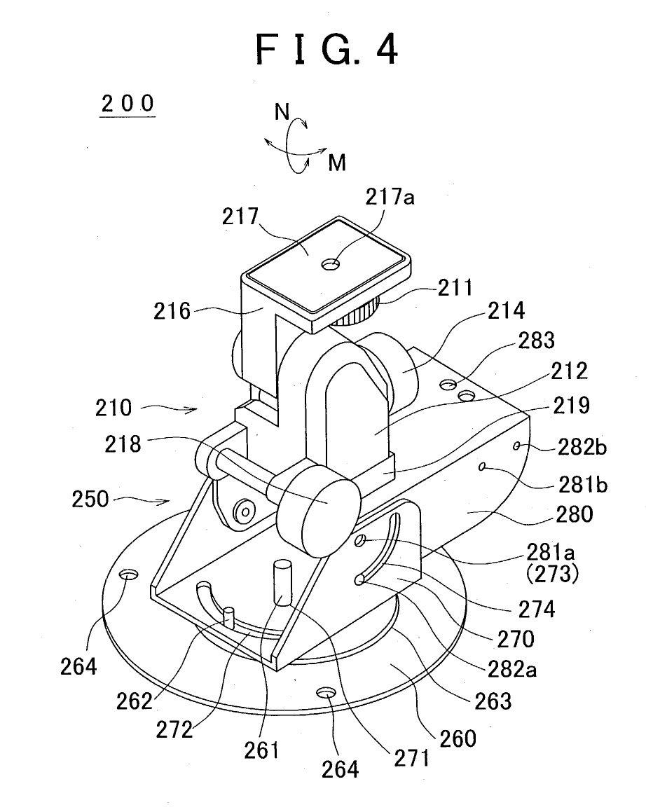

The attachment part 200 supports the communication part 100 rotatably and fixes it at a predetermined angle. The attachment part 200 includes, as shown in FIG. 4, a fine adjustment part 210 and a rotary part 250. Here, FIG. 4 is a perspective view of the attachment part 200 in the optical wireless device 10. Although the attachment part 200 of this embodiment manually adjusts and fixes an angle of the communication part 100, the present invention covers the automatic angular adjustment and fixation. Such an angular adjustment obtains through the converter part 110 for feedback control, information of whether the optical axes 4 accord with each other between two communication parts 100.

The fine adjustment part 210 includes, as shown in FIG. 4, a screw 211, first and second mobile part 212 and 216, first and second adjustment thumbscrews 214 and 218, and a bottom part 219. The fine adjustment part 210 provides a fine adjustment to an angle that has been roughly adjusted by the rotary part 250, which will be described later. The fine adjustment part 210 of this embodiment uses a pan head structurally similar to that used for a camera, an astronomical telescope, etc. The adjustment mechanism of the pan head uses, for example, an angle-adjusting gear or gears smaller than that in the rotary part, and may provide a relatively finer angular adjustment than that by the rotary part 250.

The screw 211 fixes the communication part 100 onto the fine adjustment part 210. The screw 211 includes a thumbscrew and a screw section (not shown), which perforates a hole 217a and a hole (not shown) provided in a bottom surface of the communication part 100, and fixes the communication part 100. In fixing the communication part 100 using the screw 211, the communication part 100 may be slightly inclined in a direction M in FIG. 4.

The first rotary part 212 is rotatably supported by the bottom part 219, and supports the second rotary part 216 rotatably, the first and second adjustment thumbscrews 214 and 218. The first rotary part 212 includes an angle adjustment mechanism (not shown), which includes, for example, a gear or gears, and engages with corresponding gears of the first and second adjustment thumbscrews 214, 218, second rotary part 216, and bottom part 219. The gear (not shown) in the first rotary part 212 is engaged with gears (not shown) of the first adjustment thumbscrew 218 and bottom part 219. Of course, the present invention may use a member other than a gear for the angle adjustment mechanism.

The first adjustment thumbscrew 218 rotates, when rotated by a user, a first rotary part 212 in the direction M in FIG. 4. Although the direction M is a horizontal direction in FIG. 4, it is a perpendicular direction when the optical wireless device 10 is attached to the perpendicular surface, such as a wall. In this embodiment, the first adjustment thumbscrew 218 rotates manually, but it may be an automatic angle adjustment mechanism, as described above.

The second mobile part 216 supports the communication part 100 using a fixing screw 201, and is attached rotatably to the first mobile part 212 in the direction N. The second rotary part 216 includes a support part 217 and a screw hole 217a, and is connected to the angle adjustment mechanism in the first rotary part 212. The support part 217 has a shape along the shape of the bottom surface of the communication part 100. In order to reduce the vibration to the communication part 100, an elastic member, such as rubber and sponge, is preferably provided. The screw hole 217 is used to engage the screw 211 with the communication part 100.

The second adjustment thumbscrew 214 rotates, when rotated by a user, the second rotary part 216 in the direction N. Although the direction N is a perpendicular direction in FIG. 4, it is a horizontal direction when the optical wireless device 10 is attached to the perpendicular surface, such as a wall. In this embodiment, the second adjustment thumbscrew 214 rotates manually, but it may be an automatic angle adjustment mechanism, as described above.

The bottom part 219 rotatably supports the first rotary part 212, and is fixed unrotatably by projection parts 285 on the second rotary part 280 of the rotary part 250.

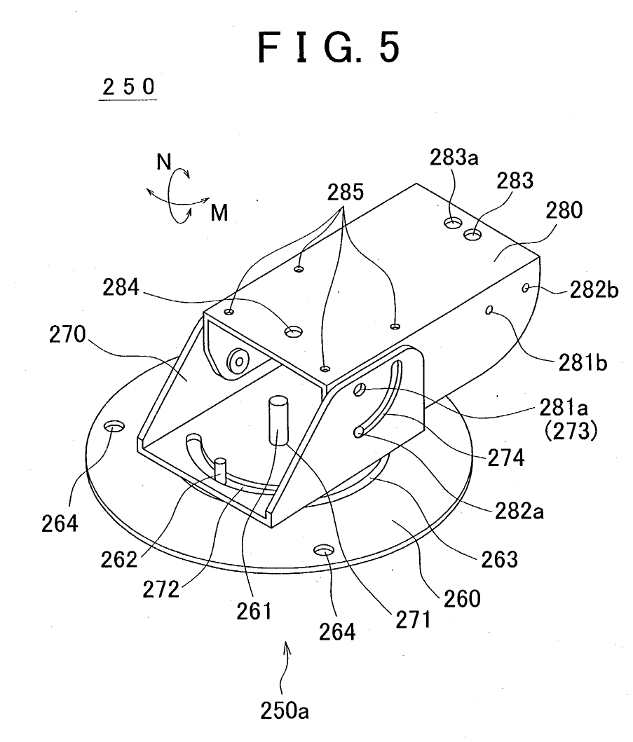

The rotary part 250 is a mechanism that serves to roughly adjust the angle of the communication part 100 to a predetermined three-dimensional angle and includes, as shown in FIG. 5, a fixing part 260, and first and second rotary parts 270 and 280. Here, FIG. 5 is a perspective view showing the rotary part 250 in the optical wireless device 10.

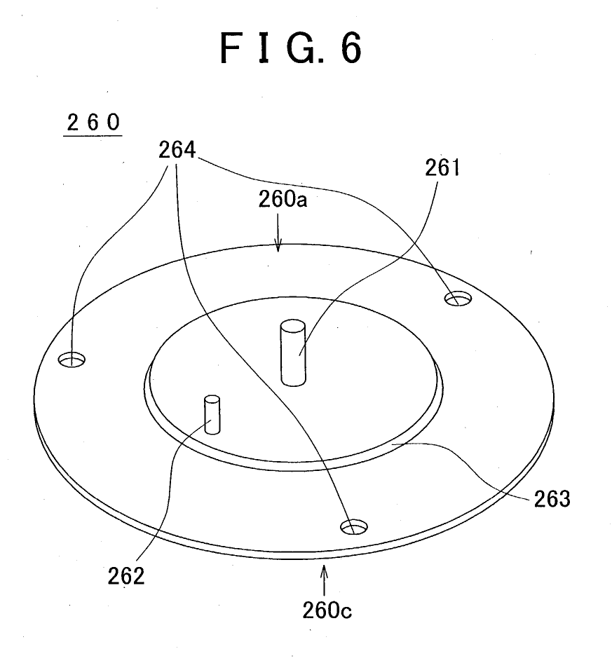

The fixing part 260 serves to fix the rotary part 250, and rotatably supports the first rotary part 270 via the fixing support part 261. The fixing part 260 is made of metal or plastic. The fixing part 260 includes, as shown in FIG. 6, a fixing support part 261, a fixing-side restriction part 262, a step 263, screw holes 264, and exemplarily has a disc shape. The disc shape maintains a broad installation area suitable for stabilization. Of course, the shape of the top surface 260a of the fixing part 260 is not limited to an approximately circle, but may be an approximately polygon if it stabilizes a fixation. Here, FIG. 6 is a perspective view of the fixing part 260 in the optical wireless device 10. The fixing part 260 is fixed onto a desired installation plane via screws and other means, so that the bottom surface 260 contacts it. The installation plane is not limited to a horizontal surface, such as a ceiling and floor, but may be a perpendicular surface, such as a wall and a partition.

The fixing support part 261 is provided at a center of the fixing part 160, engaged with a first connecting hole 271 in the first rotary part 270, which will be described later, and serves as a fulcrum of a rotary motion of the first rotary part 270. A surface of the fixing support part 261 is, for example, thread-cut so as to fix the first rotary part 270, which will be described later, at a predetermined position using a nut (not shown), thereby preventing the communication part 100 from shaking.

The fixing-side restriction part 262 cylindrically projects from the fixing-part top surface 260a, is engaged with a first rotary adjustment hole 272, which will be described later, and restricts the rotation of the first rotary part 270. The fixing support part 261 and fixing-side restriction part 262 may be inserted from the fixing part bottom surface 260c, for example, using a screw and a through bolt. The instant embodiment requires a height of the screw head to be lower than the step 263, which will be described later, and prevents the screw head from projecting from the fixing part bottom surface 260c. The step 263 has a circular shape, and is formed such that the screw head is prevented from the fixing part 260c for the fixing support part 261 and fixing-side restriction part 262, which are, for example, screwed from the fixing part bottom surface 260c using screws. Therefore, the step 263 should be made higher than the screw head. There are plural (e.g., three in this embodiment) screw holes 264 in the fixing part 260. The screw hole 264 is preferably arranged at a desired position to stabilize the fixing part 260 around the fixing support part 261. This embodiment arranges them like a triangle around the fixing support part 261 to stably fix the fixing part 260. The number of screw holes 264 is variable as long as the number and arrangement maintain the stable fixation. The screw holes 264 may be eliminated for the fixation at the installation place without using a screw. For example, a magnet is attached to the fixing part 260 for fixation. Of course, both the magnet and screw hole 264 may be provided.

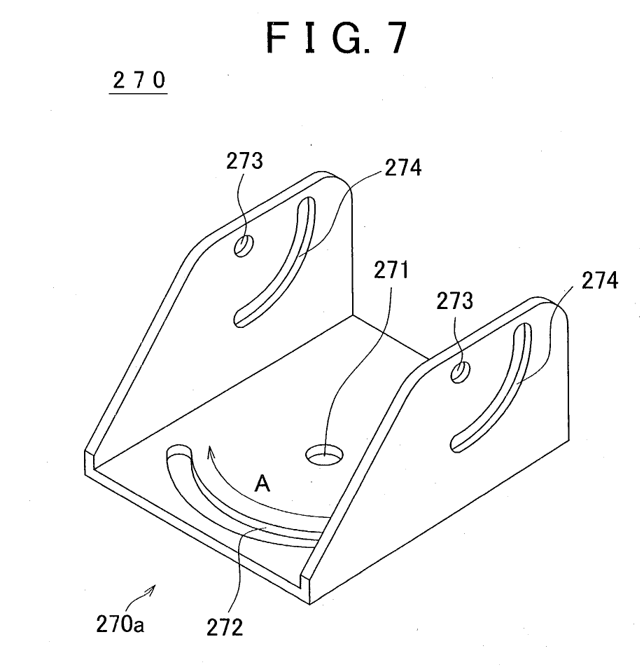

The first rotary part 270 is rotatably supported on the fixing part 260, and supports the second rotary part 280, which will be described later, rotatably in the direction N. The first rotary part 270 includes, as shown in FIG. 7, a first connecting hole 271, a first rotary adjustment hole 272, a pair of second connecting holes 273, and a pair of second rotary adjustment holes 274, and has an exemplary sectionally U-shape. Here, FIG. 7 is a perspective view of a first rotary part 270 in the optical wireless device 10.

The first connecting hole 271 is engaged with the fixing support part 261, and rotates around it as a fulcrum in a direction A. The first rotary adjustment hole 272 is engaged with the fixing-side restriction part 262, and allows the first rotary part 270 to rotate within this hole 272. When it reaches a desired position, it is fixed, for example, by a nut.

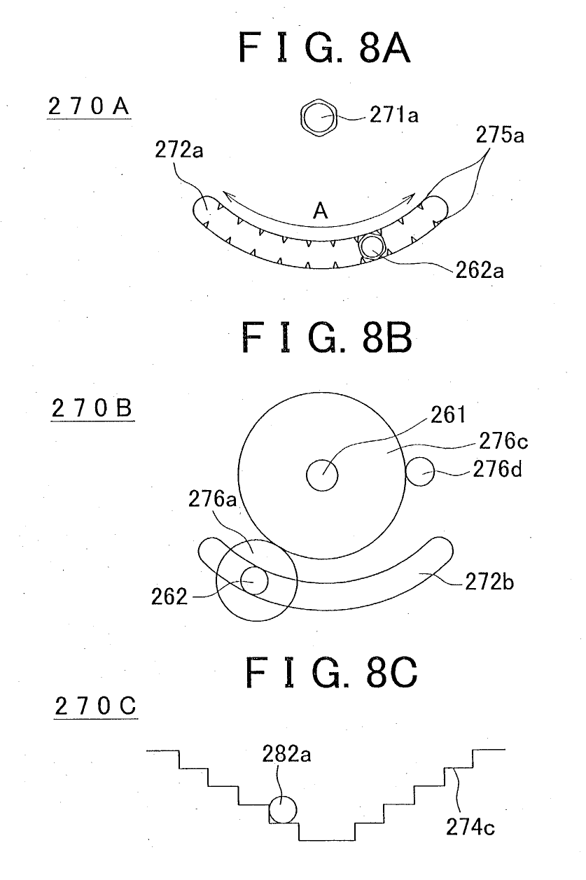

A plurality of convexes 275a that may elastically project and retreat as shown in FIG. 8(a) may be provided in the first rotary adjustment hole 272. In this case, the convex part 275 becomes engaged with the fixing-side restriction part 262 and fixes its position when the first rotary part 270 reaches the desired position. Here, FIGS. 8(a) and 8(b) are plane views as different variations of the first rotary part 270. As a result, the communication part 100 may stably communicate since the first rotary part 270 is prevented from moving out of the desired position. Preferably, the size of the convex 275 is determined such that the projection of the convex 275 contacts the fixing-side restriction part 262 but does not prevent its smooth rotary action. In addition, the length A of the first rotary adjustment hole 272 is preferably determined such that various cables (not shown) connected to the communication part 100 are not entangled with the attachment part 200. Although the variation shown in FIG. 8(a) integrates the first rotary adjustment hole 272a with the convex part 275a, they may have independent structures. In this case, for a contact with the fixing-side restriction part 262 using an elastic member, such as a spring, it is preferably configured such that it moves outward relative to the first rotary adjustment hole 272 and returns to the initial position when it does not contact the fixing-side restriction part 262. As shown in FIG. 8(b), it is possible to provide a gear 276a engaged with a rack 276b around the fixing-side restriction part 262, a gear 276c engaged with the gear 276a around the support part 261, a gear 276d engaged with the gear 276c, and a rotary shaft of the gear 276d with a knob. Thereby, a rotation of the knob would rotate the gear 276d, then rotates the gears 276c and 276a, and moves the gear 276a along the rack 276b, whereby the restriction part 262 moves long the groove 272. Of course, these variations may also serve to achieve a fixation at the predetermined angle, as in the instant embodiment.

Referring back to FIGS. 5 and 7, a second support parts 281a, which will be described later, is inserted into the second connecting hole 273. A second side restriction parts 282a is inserted into the second rotary adjustment hole 274, which allows the second rotary parts 280 to rotate in the direction N by 90 degrees in this embodiment. When it is adjusted to the desired inclined angle in the direction N, it may be fixed by a nut, for example. A plurality of convex 275 may be provided in the second rotary adjustment hole 274, as shown in FIG. 8(a). In this case, the convex part 275 becomes engaged with the second side restriction part 282a to fix its position. As a result, the communication part 100 may stably communicate since the second rotary part 280 is prevented from moving out of the desired position.

As shown in FIG. 8(c), the restriction part 282a may be moved stepwise by forming the outline of the second rotary adjustment holes 274 stepwise. Preferably in this case, it is preferable that a spring etc. force and fix the restriction part 282a after it has moved to a desired angular position. The second side restriction part 282b and second support part 281b are provided in the first rotary part 270 similar to the second side restriction part 282a and second support part 281a.

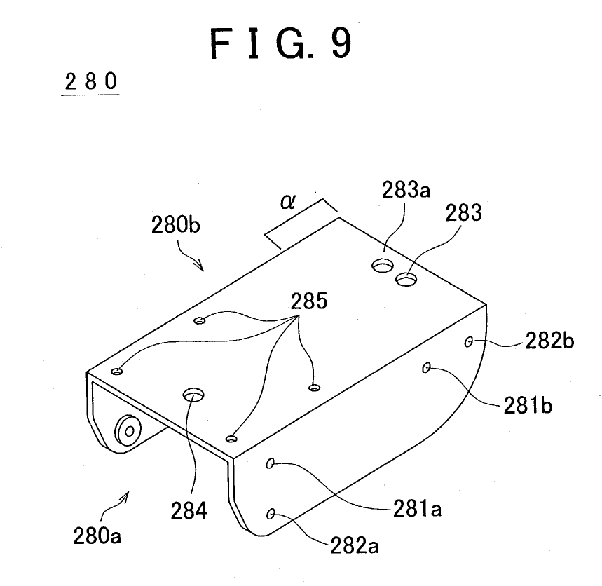

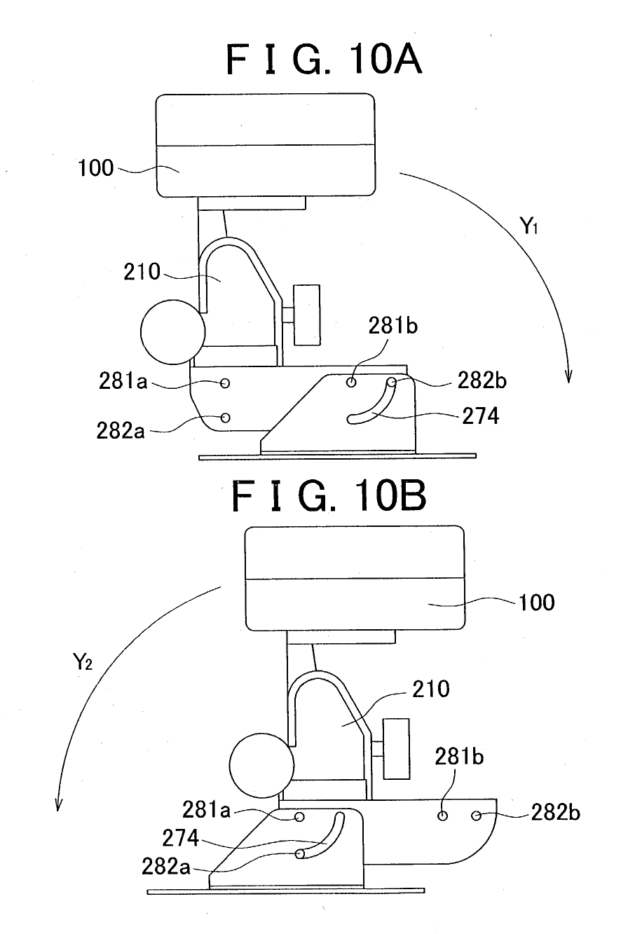

The second rotary part 280 is attached to the first rotary part 270, and rotates in a rotary direction orthogonal to the first rotary part 270. It includes, as shown in FIG. 9, second support parts 281a and 281b, second side restriction parts 282a and 282b, a cable fixing part 283, a screw hole 284, and a projection part 285, and has an exemplary sectionally U-shape opening the first rotary part 270. Here, FIG. 9 is a perspective view showing the second rotary part 280 in the optical wireless device 10. Such a shape has, when viewed from the top surface 280c, an approximately rectangle. Such a shape provides the second rotary part 280 with such an extra length a that when the communication part 100 is mounted, a communication cable connected to the rear surface (not shown) of the communication part 100 is prevented from being compressed and bent by a wall (not shown). Thereby, the extra length a of the second rotary part 280 contacts the wall, and prevents the communication cable from contacting the wall. The second rotary part 280 includes the second support part and second side restriction part at the side surface 280b (not shown), and they serve as the same functions of the members of the second support parts 281a and 281b, second side restriction parts 282a and 282b. In use, one of the second side restriction parts 282a and 282b is inserted into the second rotary adjustment hole 274, as shown in FIGS. 10(a) and 10(b). Here, FIG. 10 is a side view showing a moving direction of the second rotary part 280 in the optical wireless device 10. Therefore, the second rotary part 280 may be disassembled from the first rotary part 270.

As shown in FIG. 5, the second support part 281a is connected rotatably to the second connecting hole 273, and serves as a fulcrum for the second rotary member 280. The second support part 281a may be made of a screw, for example, which is, in turn, inserted from the side of the first rotary part 270. The second side restriction part 282a serves to restrict the rotary action of the optical wireless device 10 in the direction N in cooperation with the above second rotary adjustment hole 274. The second support part 281 a and second side restriction part 282a may be shaped like a push button type when connected to the first rotary part 270. A range in which the second side restriction part 282a and second rotary adjustment hole 274 restrict is 90° in a direction Y₁, as shown in FIG. 10(a).

As shown in FIG. 5, the second support part 281b is connected rotatably to the second connecting hole 273, and serves as a fulcrum for the second rotary member 280. The second support part 281b may be made of a screw, for example, which is, in turn, inserted from the side of the first rotary part 270. The second side restriction part 282a serves to restrict a rotary action of the optical wireless device 10 in the direction N in cooperation with the above second rotary adjustment hole 274. The second support part 281b may be shaped like a push button type when connected to the first rotary part 270. A range in which the second side restriction part 282b and second rotary adjustment hole 274 restrict is 90° in a direction Y₂, as shown in FIG. 10(b).

The cable fixing part 283 includes a pair of approximately circular holes that allow the UTP or LAN cable 5 (not shown) connected to the communication part 100 to be inserted. This cable fixing part 283 is exemplary, and it may be modified such that the plane 283 is cut out, when a cable connection terminal is larger than the cable fixing part 283, so as to insert the cable into the cutout or fix the cable using an elastic member, such as a clip.

The screw hole 284 is used to fix the fine adjustment part 210. Such a fixation does not need a screw, but may use a magnet or bonding with adhesive agent instead of using the screw hole. The projection part 285 is used to connect the fine adjustment part 210 at a predetermined position, and provided such that it contacts four corners of the fine adjustment part 210. The projection part 285 is made of the same shaped material as the second rotary part 280, but may be formed, for example, by using a shock absorbing member, thereby mitigating the external impact applied to the fine adjustment part 210 and communication part 100 in addition to positioning them.

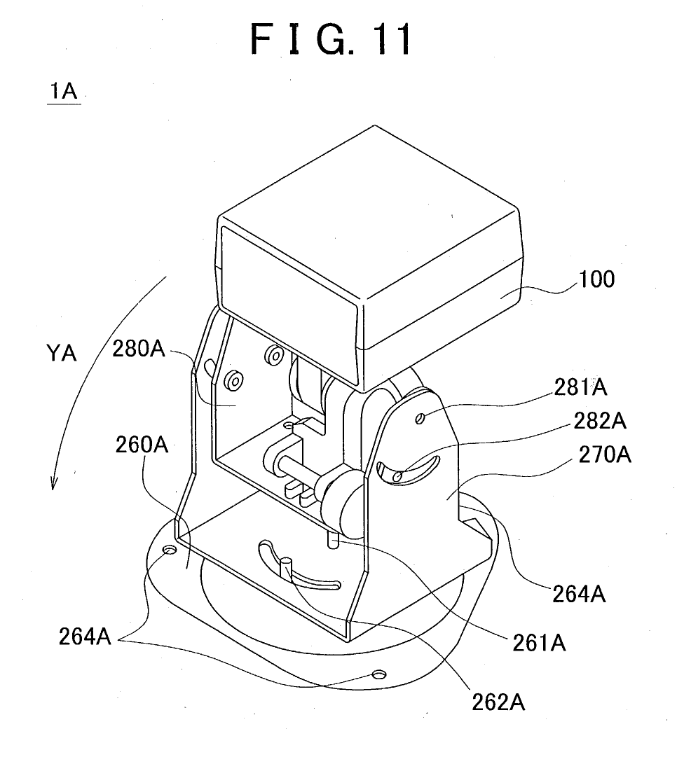

A description will now be given of a variation of the optical wireless device 10 with reference to FIG. 11. The same element in FIG. 11 as that in FIG. 2 is designated by the same reference numeral. Here, FIG. 11 is a perspective view showing a rotary part 250A as a variation of the optical wireless device 10A.

The optical wireless device 10A includes a fixing part 260A and a second rotary part 280A, and achieves similar functions to those in FIG. 2 using an approximately triangle fixing part 260A, first rotary part 270A, and second rotary part 280A. The fixing part 260A uses a three-point supporting screw holes 264A, and includes a fixing support part 261A and fixing restriction part 262A. Needless to say, these members may achieve similar functions as those in the embodiment in FIG. 2.

The second rotary part 280A is mounted on the first rotary part 270A, and rotates in a rotary direction orthogonal to the first rotary part 270A. This second rotary part 280A includes a pair of second support parts 281A, a pair of second side restriction parts 282A, a screw hole (not shown), and a projection part. Thereby, it may rotate in the direction orthogonal to the first rotary part 270, and achieve similar functions to those in the embodiment shown in FIG. 2. It has a U shape opening in the same direction as the first rotary part 270, when viewed from the front surface. Such a U-shape serves to support the fine adjustment part 210A, and be supported by the first rotary part 270A. Such a shape shortens the length by the extra length a unlike the embodiment in FIG. 2.

Referring back to FIGS. 1 and 2, a description will now be given of an attachment of the optical wireless device 10. In an attempt to install two optical wireless devices obliquely on different floors, two optical wireless devices 10a and. 10b are arranged in preset positions. As the way of arrangement, the fixing part 260 is attached to the desired position by a screw or screws. The first fixing part 270 is attached to the attached fixed part 260 using a screw. In this case, angles are adjusted and then the horizontal angles are fixed such that the optical wireless devices 10a and 10b face each other. Next, the second rotary part 280 is attached and fixed after a perpendicular angle is adjusted to a desired angle. In this case, the optical wireless device 10a irradiates light from the bottom to the top, and thus is attached to the second support part 281a and second side restriction part 282a. On the other hand, the wireless device 10b irradiates light from the top to the bottom, and thus is attached to the second support part 281b and second side restriction part 282b. The fine adjustment part 210 and communication part 100 are provided on the second rotary part 280. Then, the optical wireless devices 10a and 10b are powered on, and the laser pointer switch 140 is turned on in the optical wireless device 10a. Then, the laser beam is emitted from the laser pointer 140 in the optical wireless device 10a to the optical wireless device 10b. An operator first adjusts the position of the optical wireless device 10a such that the laser beam emitted from the laser pointer 140 is irradiated onto the front surface of the optical wireless device 10b. The position is adjusted by two-dimensionally moving the optical wireless device 10a upward and downward and rightward and leftward. Then, an operator uses the fine adjustment part 210 to adjust the position of the optical wireless device 10a again such that the laser beam emitted from the laser pointer 140 enters the collimator 150 provided on the front surface of the optical wireless device 10b. In this stage, usually, the optical axis 4 of the laser pointer 140 accords with the optical axis 4 of the transmitter part 120 and receiver part 130, whereby the optical wireless device 10b receives the laser beam output from the optical wireless device 10a. Such an angle adjustment enables the optical wireless devices 10a and 10b to communicate with each other.

Further, the present invention is not limited to these preferred embodiments, and various variations and modifications may be made without departing the scope of the present invention.

### INDUSTRIAL APPLICABILITY

The present invention may maintain the radiation position of the received optical axis, thereby avoiding arduous readjustment and providing stable information communications. The variable field angle of the optical wireless device may achieve communications irrespective of the height of the installation place and enlarge the optical wireless communication range. As a result, the easy and stable adjustment and fixation of the optical axis as well as information communications are realized irrespective of the installation position.

What is claimed is:

1. An optical wireless device comprising:
a communication part for optical communications; and
an attachment part for rotatably supporting said communication part and for fixing said communication part at a predetermined angle.

2. An optical wireless device according to claim 1, wherein said attachment part includes:
a first angle adjustment part for adjusting an angle of said communication part to the predetermined angle; and
a second angle adjustment part for providing a fine adjustment to the angle that has been adjusted by said first angle adjustment part, to the predetermined angle.

3. An optical wireless device according to claim 2, wherein said first angle adjustment part includes a first rotary part for adjusting a horizontal angle of said communication part.

4. An optical wireless device according to claim 2, wherein said first angle adjustment part includes a second rotary part for adjusting a perpendicular angle of said communication part.

5. An optical wireless device according to claim 2, wherein said first angle adjustment part includes:
a fixing part fixed at a predetermined position;
a first rotary part rotatably attached to the fixing part; and
a second rotary part attached to the first rotary part, and rotatable in a rotary direction orthogonal to the first rotary part,
wherein one of said First and second rotary parts includes a pair of first projections aligned in a first direction and a pair of second projections aligned in a second direction perpendicular to the first direction, and
wherein the other of said first and second rotary parts includes an arc-shaped groove engageable with one of the first projections and one of the second projections, and the second rotary part is rotatable with respect to the other of the first projections and the other of the second projections.

6. An optical wireless device according to claim 2, wherein said first angle adjustment part includes:
a fixing part fixed at a predetermined position;
a first rotary part rotatably attached to the fixing part; and
a second rotary part attached to the first rotary part, and rotatable in a rotary direction orthogonal to the first rotary part,
wherein one of said first and second rotary parts includes a pair of projections, and the other of said first and second rotary parts includes an arc-shaped groove engageable with one of the projections, and the second rotary part is rotatable with respect to the other of the projections.

7. An optical wireless device according to claim 1, said attachment part includes a fixing mechanism for fixing said communication part.

8. An optical wireless device according to claim 2, wherein said second angle adjustment part is a pan head.

9. An optical wireless device according to claim 1, wherein said attachment part includes an engagement part for holding a cable connected to said communication part.

10. An optical wireless device according to claim 1, said communication part includes:
a first transmitter/receiver part for emitting and receiving light for communications;
a second transmitter/receiver part for emitting and receiving light for adjusting an optical axis; and
a collimator for receiving light emitted from said second transmitter/receiver part in a communication counterpart.
